(19) United States
(12) Patent Application Publication
(10) Pub. No.: US 2016/0293038 A1
(43) Pub. Date: Oct. 6, 2016

(54) SIMULATOR FOR GENERATING AND TRANSMITTING A FLOW OF SIMULATION IMAGES ADAPTED FOR DISPLAY ON A PORTABLE COMPUTING DEVICE

(71) Applicant: CAE INC., Saint-Laurent (CA)

(72) Inventors: Frederic Dubois, Laval (CA); Dac Toan Ho, Laval (CA)

(21) Appl. No.: 14/674,790

(22) Filed: Mar. 31, 2015

(51) Int. Cl. G09B 9/02; G06T 3/40; G06T 9/00

(52) U.S. Cl. CPC G09B 9/02; G06T 9/002; G06T 3/4092; G06T 2200/16; G06T 2210/32

(57) ABSTRACT

A simulator for generating and transmitting a flow of simulation images adapted for display on a portable computing device. The simulator comprises a processing unit. The processing unit executes a simulation and further executes at least one rendering function. Each rendering function generates a flow of simulation images adapted for display on the portable computing device, and transmits the flow of simulation images to the portable computing device. The flow of simulation images is representative of the execution of the simulation. In a particular aspect, the simulator comprises a web server for receiving interaction data from the portable computing device. The processing unit processes the interaction data and controls the execution of the simulation based on the processed interaction data. In another particular aspect, the web server is executed by a standalone server instead of being executed by the simulator.

### TECHNICAL FIELD

The present disclosure relates to the field of simulators. More specifically, the present disclosure relates to a simulator for generating and transmitting a flow of simulation images adapted for display on a portable computing device.

### BACKGROUND

Flight simulators are used by commercial airlines and air forces to train their pilots to face various types of situations. A simulator is capable of simulating various functionalities of an aircraft, and of reproducing various operational conditions of a flight (e.g. takeoff, landing, hovering, etc.). A trainee (e.g. a pilot performing a training session) interacts with the simulator to control various functionalities of the simulated aircraft during a simulation executed by the simulator. Similarly, an instructor (e.g. an experienced pilot) may interact with the simulator for various purposes, including controlling a simulation currently executed by the simulator, creating or updating simulation scenarios, controlling the simulation environment of a trainee, etc.

The interactions of an instructor with a simulator are usually performed via dedicated components of the simulator, including a dedicated user interface of the simulator, a dedicated display of the simulator, etc. However, with the ubiquitous usage of portable computing devices, it becomes desirable for an instructor to have the capability to interact with the simulator through such a portable computing device. For this purpose, the portable computing device needs to execute a dedicated software for interacting with the simulator, since the simulation software executed by the simulator is generally proprietary and implements proprietary interfaces for interacting with the simulator. The dedicated software executed by the portable computing device is specifically designed and adapted for interactions with the simulator, and more specifically with each functionality of the simulator providing interactions with an instructor. However, it would be easier and more cost effective to use a standardized software, such as a web client, for interacting with the simulator from the portable computing device, and consequently to adapt the hardware and/or software architecture of the simulator for this purpose.

In particular, a simulator usually performs a real time rendering on a display of the simulator of images generated by a simulation functionality, such as a real time map in the case of a flight simulator. It is desirable for an instructor to receive a corresponding flow of images on a portable computing device.

Therefore, there is a need for a new simulator for generating and transmitting a flow of simulation images adapted for display on a portable computing device.

### SUMMARY

According to a first aspect, the present disclosure provides a simulator for generating and transmitting a flow of simulation images adapted for display on a portable computing device. The simulator comprises a processing unit. The processing unit executes a simulation and further executes at least one rendering function. Each rendering function generates a flow of simulation images adapted for display on the portable computing device, and transmits the flow of simulation images to the portable computing device. The flow of simulation images is representative of the execution of the simulation.

According to a second aspect, the present disclosure provides a system for generating and transmitting a flow of simulation images adapted for display on a portable computing device. The system comprises a simulator and a web server. The simulator comprises a processing unit and a communication interface. The processing unit executes a simulation and further executes at least one rendering function. Each rendering function generates a flow of simulation images adapted for display on the portable computing device, and transmits the flow of simulation images to the portable computing device. The flow of simulation images is representative of the execution of the simulation. The processing unit also processes interaction data and controls the execution of the simulation based on the processed interaction data. The communication interface receives the interaction data from the web server. The web server forwards the interaction data received from the portable computing device to the simulator.

### BRIEF DESCRIPTION OF THE DRAWINGS

Embodiments of the disclosure will be described by way of example only with reference to the accompanying drawings, in which:

FIG. 1 illustrates a legacy simulator;

FIGS. 2A and 2B illustrate a simulator adapted for generating and exchanging simulation data adapted for interacting with a portable computing device

FIG. 3 illustrates a plurality of portable computing devices interacting with the simulator of FIGS. 2A and 2B;

FIGS. 4A, 4B, 4C and 4D illustrate exemplary embodiments of components and functionalities of the simulator and portable computing device of FIGS. 2A and 2B;

FIGS. 5A, 5B and 5C represent an exemplary flow diagram illustrating interactions between components of the simulator and the portable computing device of FIGS. 2A and 2B; and

FIG. 6 illustrates respective displays of the simulator and portable computing device of FIGS. 2A and 2B.

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

Various aspects of the present disclosure generally address one or more of the problems related to interactions of a portable computing device with a simulator. Although the examples provided in the rest of the disclosure are in the field of aircraft simulators, the teachings of the present disclosure can also be applied to simulators of terrestrial vehicles such as tanks, maritime vehicles such as boats, etc. The simulators may also perform a real time simulation of an underground system, a mining facility, a nuclear plant, a human body, etc.

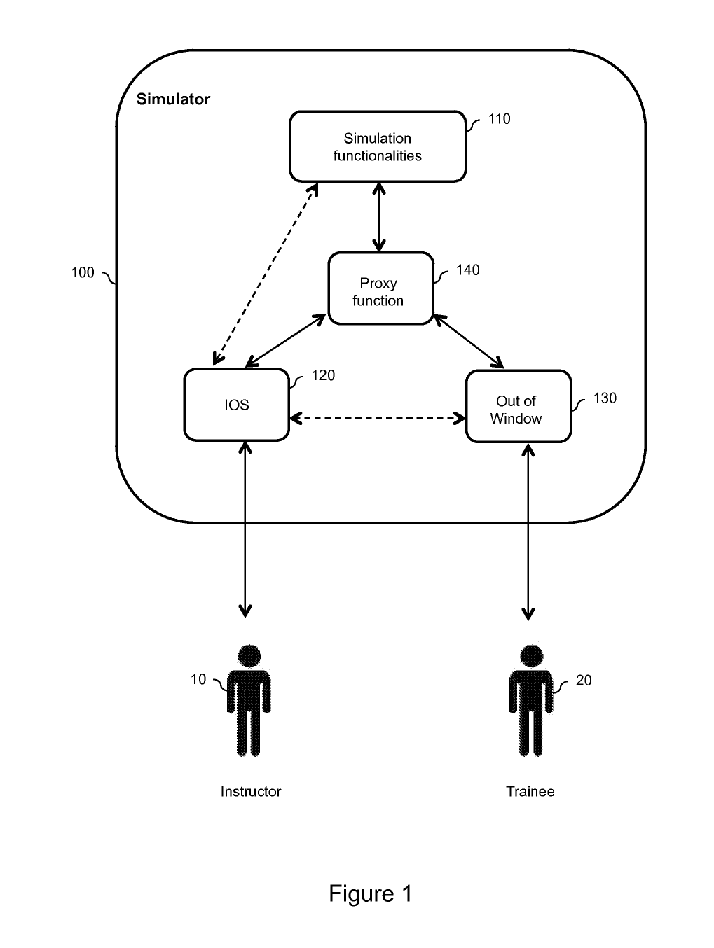

Referring now to FIG. 1, a legacy simulator 100 is represented, which does not support interactions with a portable computing device. The simulator 100 executes a simulation. The execution of the simulation is generally performed in real time and encompasses a plurality of functions, which are performed sequentially or concurrently.

The execution of the simulation comprises executing one or more simulation functionalities 110. In the case of an aircraft simulator, examples of simulation functionalities 110 include simulation of the engines, simulation of the landing gear, simulation of the electrical circuits, simulation of the hydraulic circuits, simulation of the cockpit, etc. Furthermore, the execution of a particular simulation functionality 110 may trigger the display of generated simulation data (e.g. in the form of a navigation map, a radar map, a weather map, flight map, ownship data, etc.) on a display of the simulator 100. Each simulation functionality 110 can be implemented by a dedicated software module executed by the simulator 100. The simulator 100 is capable of executing several simulation functionalities 110 in parallel, to perform an exhaustive simulation of the aircraft. Alternatively, the simulator 100 executes a single functionality 110 (or a limited number of functionalities 110) to perform a restricted simulation of the aircraft, focusing on specific systems and sub-systems of the aircraft (e.g. only the engines, only the engines and landing gear in combination, etc.).

The execution of the simulation also comprises executing at least one proxy function 140. The proxy function 140 allows other components of the simulator 100 to interact with the simulation functionalities 110. Although a single proxy function 140 is represented in FIG. 1, a plurality of proxy functions 140 may be executed concurrently, each proxy function 140 providing an interface to a specific functionality among the simulation functionalities 110.

The execution of the simulation also comprises executing an out of window functionality 130. The out of window functionality 130 allows a trainee 20 to interact with the simulator 100, and more specifically with the simulation functionalities 110 currently executed by the simulator 100 through the proxy function 140. In the case of an aircraft simulator, the out of window functionality 130 comprises displaying simulation data generated by the simulation functionalities 110 on one or more displays of the simulator 100. The displayed simulation data may include flight parameters (e.g. altitude, speed, etc.), aircraft parameters (e.g. remaining fuel, alarms, etc.), maps (e.g. navigation map, weather map, radar map, etc.), etc. The out of window functionality 130 also comprises receiving interactions from the trainee 20 via one or more user interfaces of the simulator 100. The user interface(s) may include traditional computer user interfaces (e.g. a keyboard, a mouse, a trackpad, a touch screen, etc.), as well as dedicated simulation user interfaces (e.g. switches, simulation command controls, joysticks, etc.). The interactions received from the trainee 20 are processed by the simulation functionalities 110, and affect the simulation of one or more systems of the aircraft.

The execution of the simulation also comprises executing an Instructor Operating Station (IOS) functionality 120. The IOS functionality 120 allows an instructor 10 to interact with the simulator 100, and more specifically with the simulation functionalities 110 currently executed by the simulator 100 through the proxy function 140. For instance, IOS pages are displayed on a display of the simulator 100, allowing the instructor 10 to control in real time the execution of a particular simulation scenario implemented by the simulation functionalities 110. The IOS pages consist in a Graphical User Interface (GUI) displayed on a display of the simulator 100. The GUI comprises graphical control elements (e.g. menus and sub-menus, list boxes, etc.) for controlling the execution of the simulation (e.g. modifying simulation parameters) and graphical display elements (e.g. images, text fields, icons, embedded videos, etc.) for displaying simulation data generated by the simulation functionalities 110. In the case of an aircraft simulator, the instructor 10 interacts with the IOS pages via one or more user interfaces (e.g. a keyboard, a mouse, a trackpad, a touch screen, etc.) to configure and/or update simulation parameters (e.g. weather conditions, flight plan, etc.). The configured/updated simulation parameters are processed by the simulation functionalities 110, and affect the simulation of one or more systems of the aircraft.

In a legacy operating mode, the IOS functionality 120 may interact directly with the simulation functionalities 110, without using the proxy function 140. The IOS functionality 120 may also allow the instructor 10 to interact directly with the out of window functionality 130 to perform limited functions, such as shutting down the out of window functionality 130.

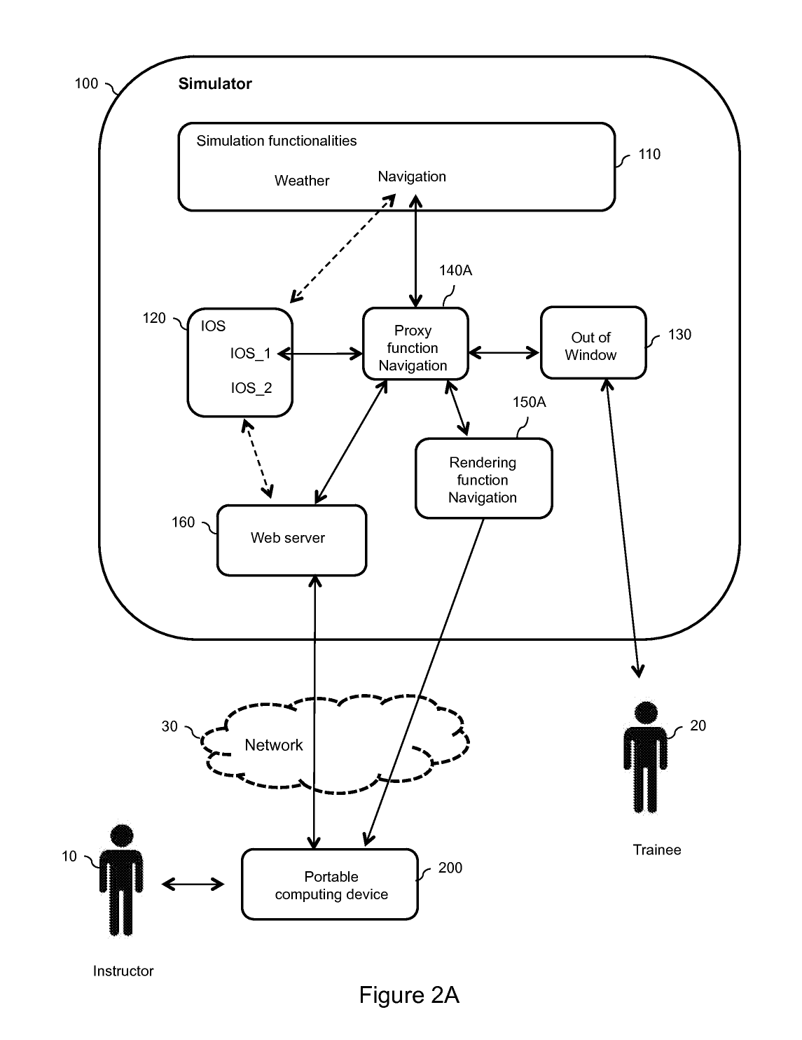

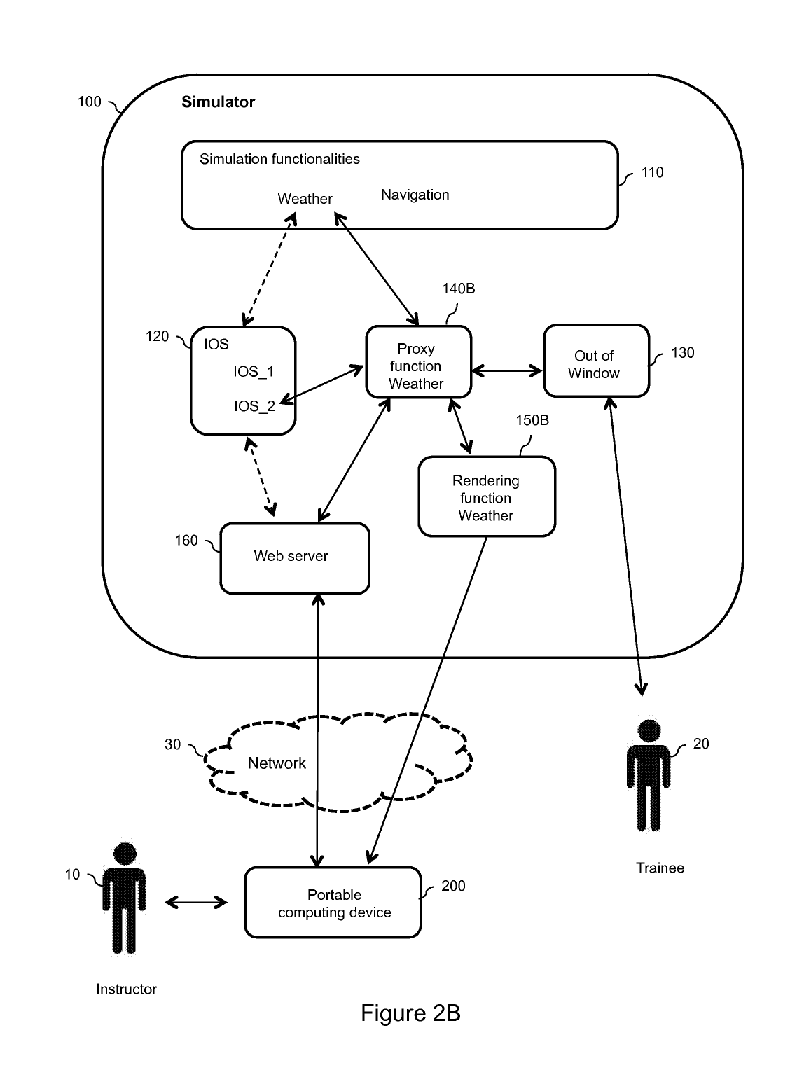

Referring now concurrently to FIGS. 2A and 2B, a simulator 100 is represented, which supports interactions with a portable computing device 200. The simulator 100 of FIGS. 2A and 2B is similar to the simulator of FIG. 1, but has been adapted to further support the interactions with the portable computing device 200.

The simulator 100 executes a simulation, which comprises executing one or more simulation functionalities 110, executing one or more proxy functions (e.g. 140A and 140B) corresponding to the simulation functionalities 110, executing an out of window functionality 130, and executing an IOS functionality 120; as previously described in relation to FIG. 1. For illustration purposes, the simulation functionalities 110 comprise two functions: a Weather function and a Navigation function. A proxy function 140A represented in FIG. 2A interfaces the Navigation function of the simulation functionalities 110 with other components of the simulator 100 (e.g. out of window functionality 130 and function IOS_1 of the IOS functionality 120). A proxy function 140B represented in FIG. 2B interfaces the Weather function of the simulation functionalities 110 with other components of the simulator 100 (e.g. out of window functionality 130 and function IOS_2 of the IOS functionality 120). As mentioned previously, in a legacy operating mode, the IOS functions IOS_1 and IOS_2 may interact directly with respectively the Navigation function and the Weather function, without using the proxy functions 140A and 140B.

The trainee 20 interacts with the out of window functionality 130 via display(s)/user interface(s) of the simulator 100, as previously described in relation to FIG. 1. Although not represented in FIGS. 2A and 2B for simplification purposes, the instructor 10 can still interact with the IOS functionality 120 via display(s)/user interface(s) of the simulator 100, as previously described in relation to FIG. 1. Furthermore, the instructor 10 now has the capability to interact with the IOS functionality 120 via the portable computing device 200.

The portable computing device 200 may consist in various types of computing devices having a form factor allowing easy carrying. Examples of such portable computing devices 200 include laptops, tablets, etc.

The portable computing device 200 exchanges data with the simulator 100 over a network 30. The network 30 may consist of a mobile network (e.g. a Wi-Fi network or cellular network), a fixed network (e.g. an Ethernet network), a combination thereof, etc. The simulator 100 and the portable computing device 200 both include a communication interface compatible with the network 30, for exchanging data. For example, the simulator 100 may comprise a communication interface supporting both Wi-Fi and Ethernet, to easily adapt to a particular network 30 deployed at the premises where the simulator 100 is operating.

The simulator 100 comprises a web server 160 for exchanging data between the simulator 100 and the portable computing device 200. The instructor 10 initiates a web session between the web server 160 and a web client implemented by the portable computing device 200, as will be detailed later in the description. Once the web session is set up, data can be exchanged between the simulator 100 and the portable computing device 100 via this web session.

The simulator 100 further executes at least one rendering function. Each instance of rendering function (e.g. 150A in FIG. 2A and 150B in FIG. 2B) is launched by the web server 160, after the aforementioned web session has been initiated, as will be detailed later in the description. Each instance of rendering function (e.g. 150A and 150B) generates simulation data adapted for rendering on the portable computing device 200. The simulation data are representative of the execution of the simulation by the simulator 100. Each instance of rendering function (e.g. 150A and 150B) directly transmits the simulation data adapted for rendering to the portable computing device 200.

More specifically, the simulation data adapted for rendering correspond to simulation data generated by the simulation functionalities 110, transmitted to a particular rendering function by a corresponding proxy function, and adapted by the particular rendering function. For instance, as illustrated in FIG. 2A, the Navigation function of the simulation functionalities 110 generates simulation data transmitted to the Navigation rendering function 150A via the Navigation proxy function 140A. The Navigation rendering function 150A adapts the simulation data for rendering on the portable computing device 200 and transmits the adapted simulation data to the portable computing device 200. Similarly, as illustrated in FIG. 2B, the Weather function of the simulation functionalities 110 generates simulation data transmitted to the Weather rendering function 150B via the Weather proxy function 140B. The Weather rendering function 150B adapts the simulation data for rendering on the portable computing device 200 and transmits the adapted simulation data to the portable computing device 200. The rendering functions 150A and 150B have been represented in two different Figures for simplification purposes. However, at any time, a single rendering function (e.g. 150A or 150B) or a plurality of rendering functions (e.g. 150A and 150B) may be generating and transmitting adapted simulation data to the portable computing device 200. Furthermore, although only two proxy functions and two rendering functions are represented in FIGS. 2A and 2B, any number of proxy functions and rendering functions may be supported by the simulator 100, corresponding to a plurality of functions implemented by the simulation functionalities 110.

The web server 160 also receives interaction data from the portable computing device 200. The interaction data represent interactions of the instructor 10 with the portable computing device 200, in relation to data received by the portable computing device 200 from the simulator 100 and displayed on a display of the portable computing device 200. The instructor 10 interacts via a user interface (e.g. a keyboard, a mouse, a trackpad, a touch screen, etc.) of the portable computing device 200 with the displayed data, and the interaction data are generated based on this interaction. The interaction data received by the web server 160 are processed by the simulator 100 to further control the execution of the simulation based on the processed interaction data. For instance, the instructor 10 has the capability to interact with the IOS functionality 120 directly from its portable computing device 200 to control the execution of the simulation by the simulator 100, without using the user interfaces of the simulator 100. This provides flexibility to the instructor 10, who does not need to be in close vicinity of the simulator 100 for controlling it.

For instance, function IOS_1 of the IOS functionality 120 transmits IOS control data (e.g. a control web page) to the portable computing device 200 for controlling the execution of the Navigation function of the simulation functionalities 110. The control data are transmitted by function IOS_1 to the Navigation proxy function 140A, to the web server 160 and to the portable computing device 200 for display. The instructor 10 interacts with the displayed control data (e.g. control web page) and generates interaction data. The interaction data are transmitted by the portable computing device 200 to the web server 160, to the Navigation proxy function 140A and to the function IOS_1. The function IOS_1 processes the interaction data and controls the execution of the Navigation function of the simulation functionalities 110 based on the processed interaction data, via the Navigation proxy function 140A.

Similarly, function IOS_2 of the IOS functionality 120 transmits IOS control data (e.g. a control web page) to the portable computing device 200 for controlling the execution of the Weather function of the simulation functionalities 110. The control data are transmitted by function IOS_2 to the Weather proxy function 140B, to the web server 160 and to the portable computing device 200 for display. The instructor 10 interacts with the displayed control data (e.g. control web page) and generates interaction data. The interaction data are transmitted by the portable computing device 200 to the web server 160, to the Weather proxy function 140B and to the function IOS_2. The function IOS_2 processes the interaction data and controls the execution of the Weather function of the simulation functionalities 110 based on the processed interaction data, via the Weather proxy function 140B.

More generally, the web server 160 transmits data to the portable computing device 200, which do not need to be processed by one of the instances of rendering function (e.g. 150A and 150B) to be adapted for rendering on the portable computing device 200. Such data include control data (e.g. a control web page) generated by the IOS functionality 120, as mentioned previously. Such data may also include complementary simulation data generated by one of the simulation functionalities 110. For instance, the Navigation function of the simulation functionalities 110 generates complementary simulation data (e.g. parameters of the simulation such as wind speed, events of the simulation such as aircraft speed too high, etc.) transmitted to the Navigation proxy function 140A, which are transmitted to the web server 160, and further transmitted to the portable computing device 200. The parameters and/or events can be displayed on the display of the portable computing device 200 in the form of icons, text fields, etc. For instance, the parameters and/or events constitute additional simulation information displayed in complement of a Navigation map generated by the Navigation rendering function 150A based on simulation data generated by the Navigation function of the simulation functionalities 110. The Navigation map is adapted for rendering on the portable computing device 200, and is displayed on the display of the portable computing device 200. The complementary simulation data transmitted by the web server 160 may also include data generated by the out of window functionality 130.

In an alternative embodiment, a single proxy function 140 may be used for interfacing the simulation functionalities 110 with the other components of the simulator 110. Thus, the IOS functionality 120, the web server 160 and the instances of rendering function (e.g. 150A and 150B) interface with this single proxy function 140. However, a solution with a plurality of proxy functions (e.g. 140A and 140B) is preferred for scalability reasons.

In another alternative embodiment, the single proxy function 140 or a plurality of proxy functions (e.g. 140A and 140B) may be used for interfacing with a visual database (not shown in the Figures). The visual database contains data (e.g. terrain, buildings, 3D models, etc.) that can be streamed and displayed on the portable computing device 200, via an instance of rendering function (e.g. 150A or 150B). The visual database also contains parameters and/or events that can be overlaid on the displayed data, after transmission to the portable computing device 200 via the instance of rendering function (e.g. 150A or 150B).

In still another alternative embodiment, the web server 160 may interface directly with the IOS functionality 120 without using the intermediate proxy function 140, for exchanging data between the portable computing device 200 and the IOS functionality 120 (e.g. IOS control data directly transmitted via the web server 160 to the portable computing device 200 and interaction data directly received via the web server 160 from the portable computing device 200).

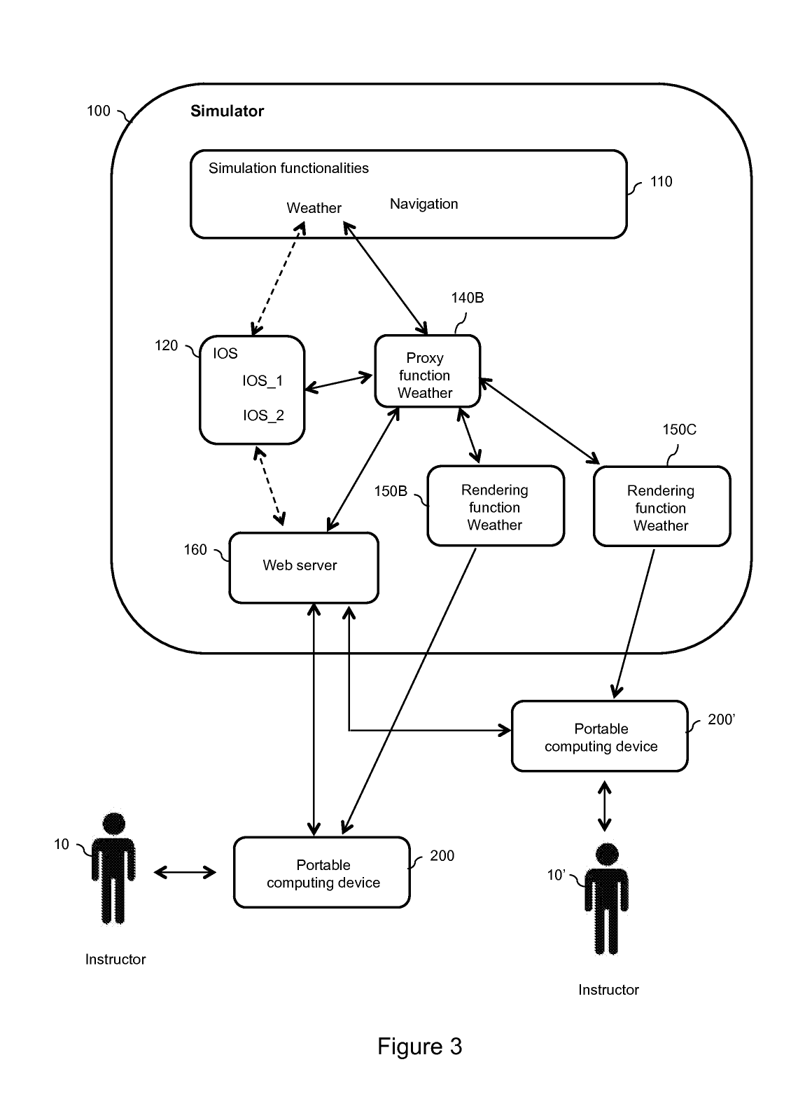

Referring now to FIG. 3, a plurality of instances of Weather rendering function (150B and 150C) for adapting simulation data generated by the Weather function of the simulation functionalities 110 are represented. The out of window functionality 130 of FIGS. 2A and 2B is not represented in FIG. 3 for simplification purposes. Although two instances of Weather rendering function (150B and 150C) are represented in FIG. 3, a larger number of instances can be operating simultaneously.

Each instance of Weather rendering function 150B and 150C is dedicated to a different portable computing device, respectively 200 and 200′. The Weather function of the simulation functionalities 110 generates simulation data transmitted to the Weather rendering function 150B via the Weather proxy function 140B. The Weather rendering function 150B adapts the simulation data for rendering on the portable computing device 200 and transmits the adapted simulation data to the portable computing device 200. Similarly, simulation data generated by the Weather function of the simulation functionalities 110 are transmitted to the Weather rendering function 150C via the Weather proxy function 140B. The Weather rendering function 150C adapts the simulation data for rendering on the portable computing device 200′ and transmits the adapted simulation data to the portable computing device 200′. The adapted simulation data transmitted to the portable computing devices 200 and 200′ may differ, based on specific characteristics of each of the portable computing devices 200 and 200′. For instance, a Weather map with a better resolution may be generated for the portable computing devices 200 than for the portable computing device 200′.

Alternatively, each portable computing device may be receiving adapted simulation data corresponding to different simulation functionalities 110. For example, the portable computing device 200′ receives a Weather map generated by the Weather rendering function 150C as illustrated in FIG. 3; and the portable computing device 200 receives a Navigation map generated by the Navigation rendering function 150A as illustrated in FIG. 2A.

The portable computing devices 200 and 200′ can also exchange data with the web server 160 concurrently. For example, they both receive IOS control data (e.g. a control web page) from the IOS functionality 120 for respectively allowing a control of the execution of a function of the simulation functionalities 110. As mentioned previously in relation to FIGS. 2A and 2B, the IOS control data are transmitted by the simulator 100 via the web server 160. They also both transmit interaction data to the IOS functionality 120 for respectively controlling the execution of a function of the simulation functionalities 110. As mentioned previously in relation to FIGS. 2A and 2B, the interaction data are received by the simulator 100 via the web server 160. The portable computing devices 200 and 200′ may be interacting with the same IOS function (e.g. IOS_1) of the IOS functionality 120, or with different IOS functions (e.g. IOS_1 and IOS_2 respectively) of the IOS functionality 120. Additionally, the portable computing devices 200 and 200′ may be controlling the same function (e.g. Weather) of the simulation functionalities 110 via the IOS functionality 120, or different functions (e.g. Navigation and Weather respectively) of the simulation functionalities 110 via the IOS functionality 120.

As mentioned previously in relation to FIGS. 2A and 2B, the portable computing devices 200 and 200′ can also concurrently receive via the web server 160 simulation data which do not need to be processed by a rendering function. The portable computing devices 200 and 200′ may be receiving simulation data via the web server 160 from the same function (e.g. Weather) of the simulation functionalities 110, or from different functions (e.g. Navigation and Weather respectively) of the simulation functionalities 110.

As illustrated in FIG. 3, at least one additional instructor 10′ (or possibly another type of participant involved in the simulation) can interact with the simulator 100 via another portable computing device 200′, concurrently to the instructor 10. The web server 160 manages the interactions with the simulator 100 via a portable computing device (e.g. 200 and 200′) of multiple users (e.g. 10 and 10′) having different access rights, as will be detailed later in the description. The web server 160 can provide concurrent and simultaneous interactions with the simulator 100 to two or more portable computing devices (e.g. 200 and 200′), by interfacing these devices with the IOS functionality 120 and the simulation functionalities 110, and by creating on demand instances of rendering functions 150 for adapting and transmitting simulation data (e.g. maps) which need to be adapted for rendering on the portable computing devices.

Referring now concurrently to FIGS. 2A, 2B 4A, 4B, 4C and 4D, exemplary embodiments of components and functionalities of the simulator 100 and portable computing device 200 are represented.

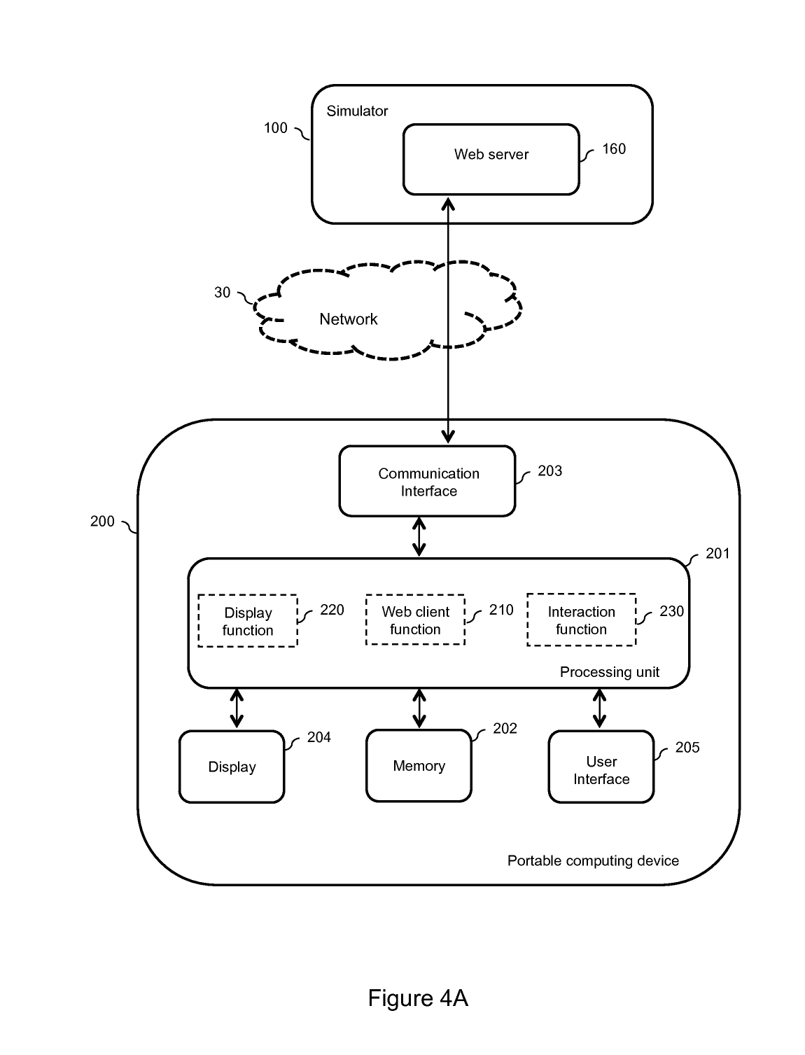

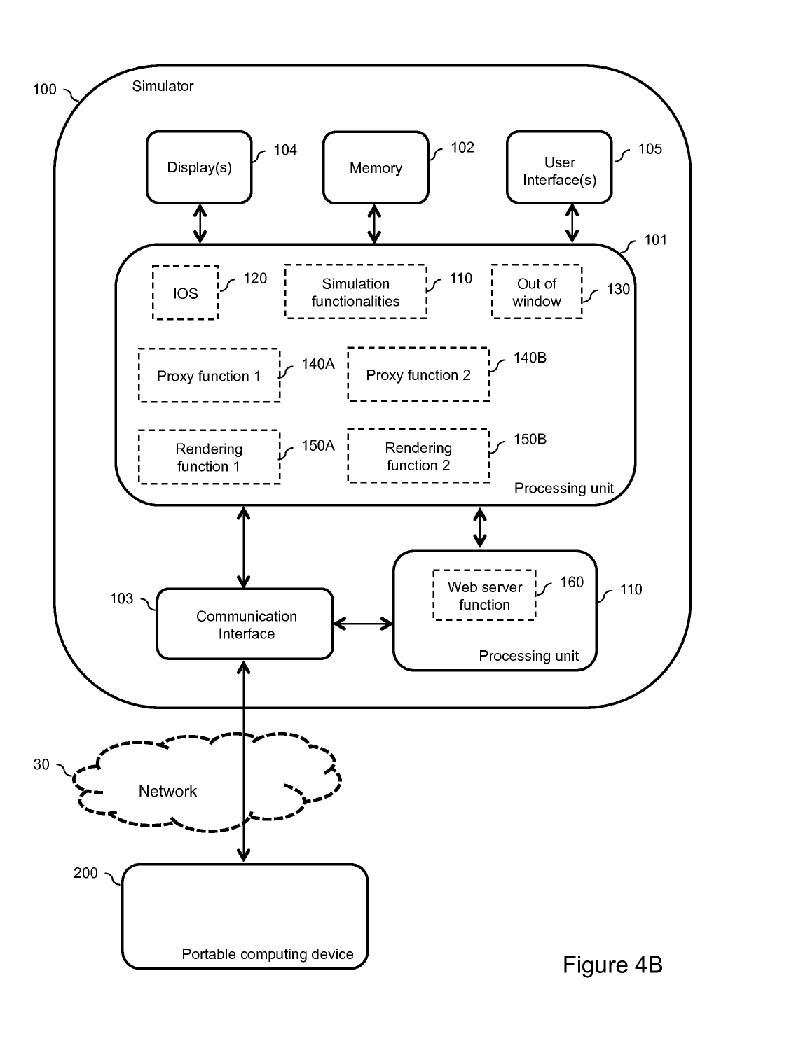

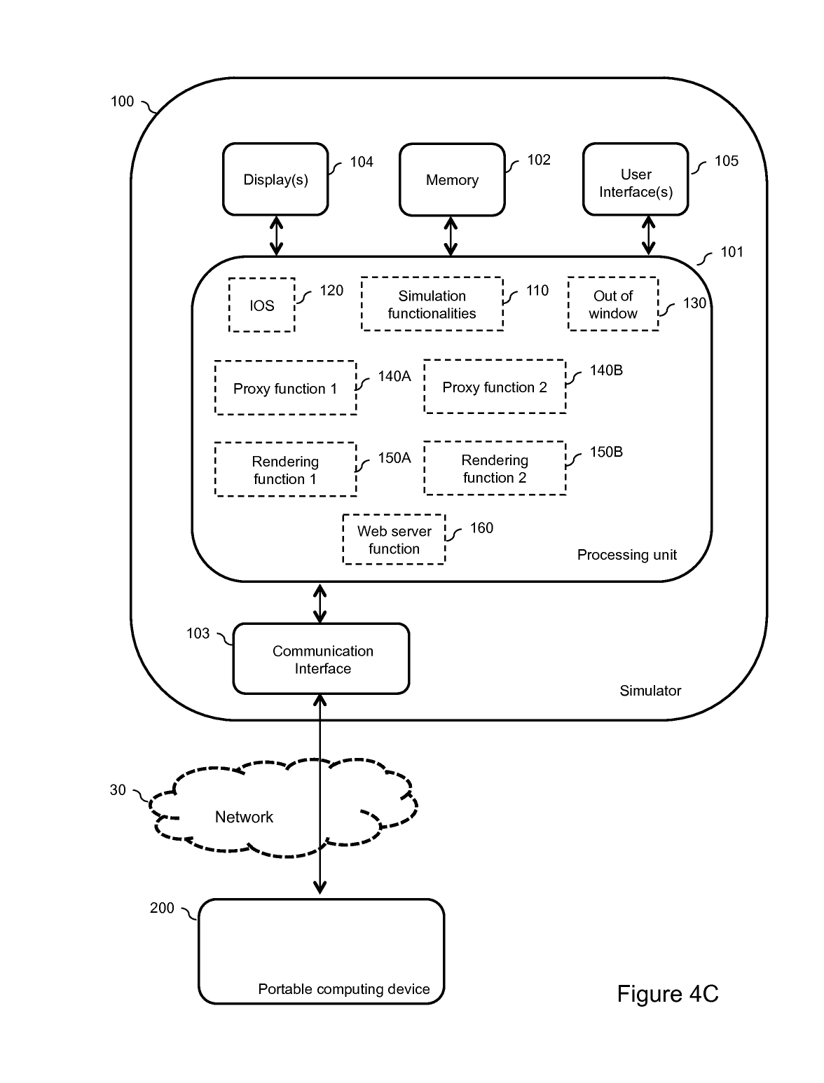

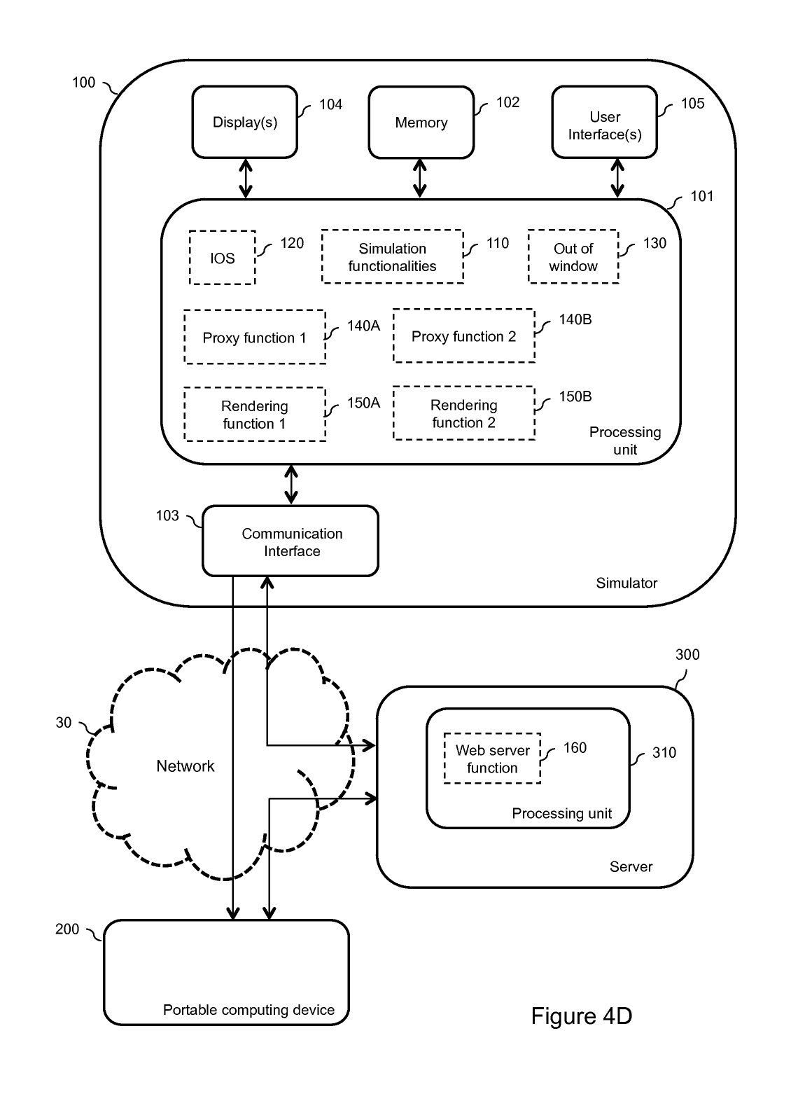

Referring more specifically to FIGS. 2A, 2B and 4A, the simulator 100 is represented in FIG. 4A with the web server 160 only for simplification purposes. The portable computing device 200 comprises a processing unit 201, having one or more processors (not represented in FIG. 4A for simplification purposes) capable of executing instructions of computer program(s). Each processor may further have one or several cores.

The portable computing device 200 comprises memory 202 for storing instructions of the computer program(s) executed by the processing unit 201, data generated by the execution of the computer program(s), data received via a communication interface 203, etc. The portable computing device 200 may comprise several types of memories, including volatile memory, non-volatile memory, etc.

The portable computing device 200 comprises the communication interface 203, for exchanging data with other entities, in particular with the simulator 100 through the network 30. The communication interface 203 supports one of more communication protocols, such as Wi-Fi, Ethernet, etc.

The portable computing device 200 comprises a display 204 (e.g. a regular screen or a tactile screen) for displaying data processed and/or generated by the processing unit 201. The portable computing device 200 also comprises at least one user interface 205 (e.g. a mouse, a keyboard, a trackpad, a touchscreen, etc.) for allowing a user to interact with the portable computing device 200.

The processing unit 201 executes a web client function 210, for establishing a web session with the web server 160 of the simulator 100 and exchanging data (e.g. receiving IOS control data and sending interaction data) with the simulator 100. The web client function 210 performs the exchange of data with the simulator 100 through the communication interface 203 over the network 30.

The processing unit 201 executes a display function 220, for processing the data received from the simulator 100 via the communication interface 203, and displaying the processed data on the display 204. As mentioned previously, the data are received from either the web server 160, or an instance of rendering function (e.g. 150A or 150B) represented in FIGS. 2A and 2B.

The processing unit 201 executes an interaction function 230, for generating interaction data based on the interactions of the user (via the user interface 205) with the processed data displayed on the display 204. The interaction data are transmitted to the web server 160 through the communication interface 203.

The display function 220, web client function 210 and interaction function 230 are implemented by one or more computer programs. Each computer program comprises instruction for implementing the corresponding function when executed by the processing unit 201. The instructions are comprised in a computer program product (e.g. memory 202), and are deliverable via an electronically-readable media, such as a storage media (e.g. a USB key or a CD-ROM) or the network 30 (through the communication interface 203).

Although a single portable computing device 200 is represented in FIG. 4A (as well as in FIGS. 4B, 4C and 4D), the web server 160 can manage a plurality of portable computing device 200 interacting concurrently and simultaneously with the simulator 100, as will be detailed later in the description.

Referring more specifically to FIGS. 2A, 2B and 4B, the simulator 100 comprises a first processing unit 101, having one or more processors (not represented in FIG. 4B for simplification purposes) capable of executing instructions of computer program(s). Each processor may further have one or several cores. The first processing unit 101 is dedicated to implementing functionalities of the simulator 100 which will be detailed later.

The simulator 100 comprises memory 102 for storing instructions of the computer program(s) executed by the processing unit 101, data generated by the execution of the computer program(s), data received via a communication interface 103, etc. The simulator 100 may comprise several types of memories, including volatile memory, non-volatile memory, etc.

The simulator 100 comprises a second processing unit 110, having one or more processors (not represented in FIG. 4B for simplification purposes) capable of executing instructions of computer program(s). Each processor may further have one or several cores. The second processing unit 110 is dedicated to implementing the web server 160 of the simulator 100. The second processing unit 110 may have its own memory (not represented in FIG. 4B), or may share memory 102 with the first processing unit 101.

The simulator 100 comprises the communication interface 103, for exchanging data with other entities. The first processing unit 101 (when executing the rendering functions 150A, 150B, etc.) and the second processing unit 110 (when executing the web server function 160) exchange data with the portable computing device 200 via the communication interface 103 through the network 30. The communication interface 103 supports one of more communication protocols, such as Wi-Fi, Ethernet, etc. In a particular embodiment, the communication interface 103 is dedicated to the second processing unit 110 for implementing the web server 160, and the first processing unit 101 uses another communication interface not represented in FIG. 4B.

The simulator 100 comprises one or more displays 104 (e.g. a regular screen or a tactile screen) for displaying data processed and/or generated by the processing unit 101. The simulator 100 also comprises one or more user interface 105 (e.g. traditional computer user interfaces as well as dedicated simulation user interfaces) for allowing a user (e.g. trainee 20 or instructor 10) to interact directly with the simulator 100.

The first processing unit 101 executes the IOS functionality 120, the simulation functionalities 110, the out of window functionality 130, and the proxy functions (e.g. 140A and 140B), which have been described previously in relation to FIGS. 1, 2A and 2B. The IOS functionality 120 and the out of window functionality 130 allow a user (respectively the instructor 10 and trainee 20 of FIG. 1) to interact directly with the simulator 100 via its display(s) 104 and user interface(s) 105.

The first processing unit 101 also executes one or more instances of rendering function (e.g. 150A and 150B), which have been described previously in relation to FIGS. 2A and 2B. The instances of rendering function (e.g. 150A and 150B) generate simulation data adapted for rendering on the portable computing device 200, and directly transmit the adapted simulation data to the portable computing device 200.

The second processing unit 110 executes the web server function 160, which has been described previously in relation to FIGS. 2A and 2B. Data generated by the IOS functionality 120 or the simulation functionalities 110, which do not need to be adapted by a rendering function (e.g. 150A and 150B), are transmitted by the web server function 160 to the portable computing device 200 via the communication interface 103. Interaction data transmitted by the portable computing device 200 are received by the web server function 160 via the communication interface 103. The received interaction data are transmitted by the web server function 160 to the IOS functionality 120 for further processing.

In an alternative embodiment not represented in the Figures, the instances of rendering function (e.g. 150A and 150B) may be executed by the second processing unit 110, along with the web server 160.

Referring more specifically to FIG. 4C, an alternative embodiment of the simulator 100 is represented. In this embodiment, the web server function 160 is executed by the same processing unit 101, which executes the other functionalities of the simulator 100 (IOS functionality 120, simulation functionalities 110, out of window functionality 130, instances of rendering function 150A and 150B).

Referring more specifically to FIG. 4D, another alternative embodiment of the simulator 100 is represented. In this embodiment, the web server function 160 is not implemented in the simulator 100. The web server function 160 is executed by a processing unit 310 of a standalone server 300. As mentioned previously in relation to FIGS. 4B and 4C, adapted simulation data generated by the instances of rendering function (e.g. 150A and 150B) are transmitted directly to the portable computing device 200 via the communication interface 103. Data generated by the IOS functionality 120 or the simulation functionalities 110, which do not need to be adapted by a rendering function (e.g. 150A and 150B), are transmitted to the web server function 160 of the server 300 via the communication interface 103 of the simulator 100. These data are forwarded by the web server function 160 to the destination portable computing device 200. Similarly, interactions data generated by the portable computing device 200 are transmitted to the web server function 160 of the server 300. The interaction data are forwarded by the web server function 160 to the IOS functionality 120 for further processing, via the communication interface 103 of the simulator 100. The server 300 also comprises a communication interface (not represented in FIG. 4D for simplification purposes) for exchanging data with the simulator 100 and portable computing device 200. In this alternative embodiment, the web server function 160 executed by the processing unit 310 of the server 300 can support a plurality of simulators 100, which may be located at the same or at different premises.

In an alternative embodiment not represented in the Figures, the instances of rendering function (e.g. 150A and 150B) may be executed by the processing unit 310 of the standalone server 300, along with the web server 160.

The IOS functionality 120, the simulation functionalities 110, the out of window functionality 130, the proxy functions (e.g. 140A and 140B), the instances of rendering function (e.g. 150A and 150B), and the web server function 160 are implemented by one or more computer programs. Each computer program comprises instruction for implementing the corresponding function when executed by a processing unit (respectively 101 or 110 in FIG. 4B, 101 in FIG. 4C, respectively 101 or 310 in FIG. 4D). The instructions are comprised in a computer program product (e.g. a memory), and are deliverable via an electronically-readable media, such as a storage media (e.g. a USB key or a CD-ROM) or the network 30 (through a communication interface).

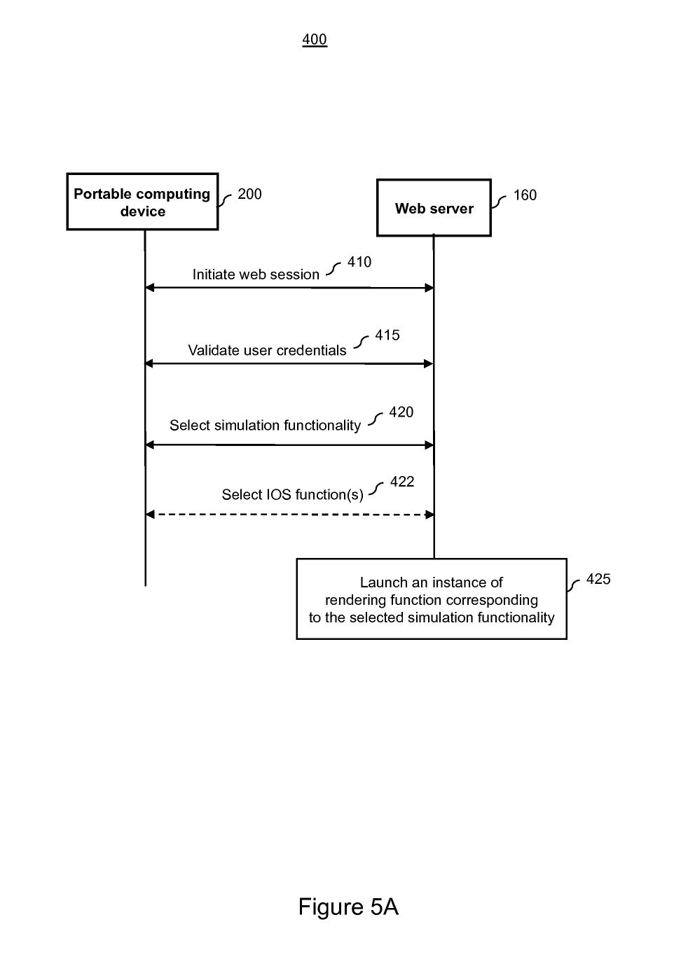

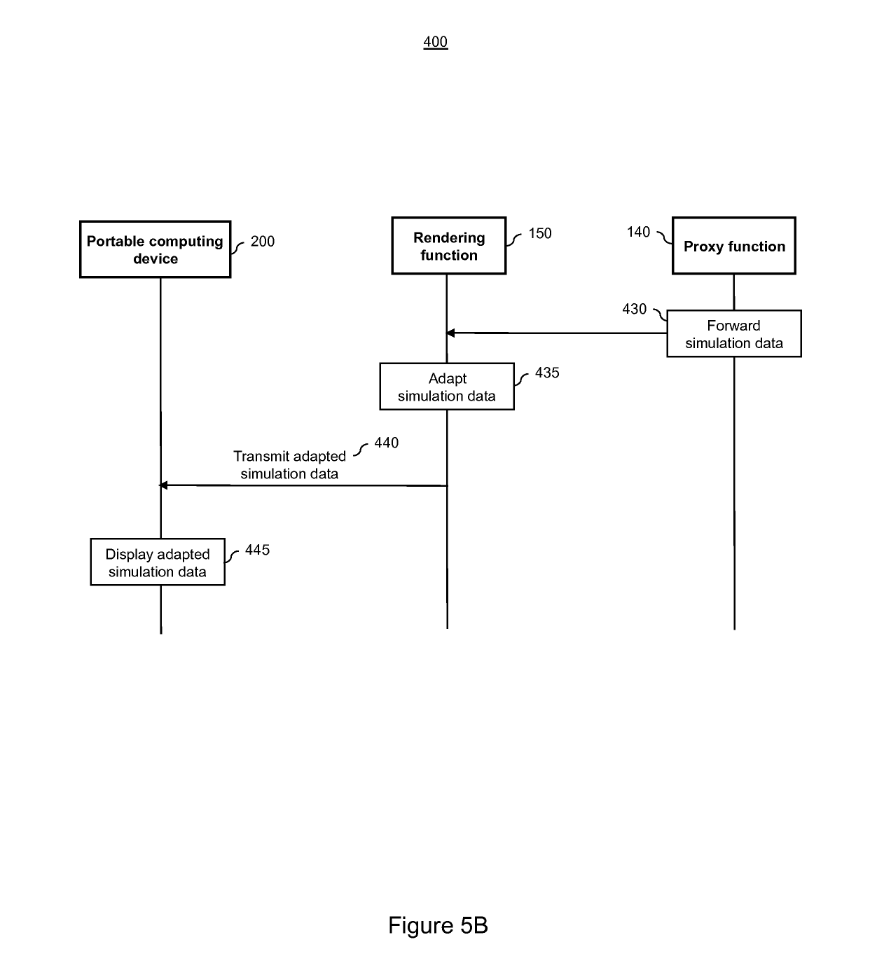

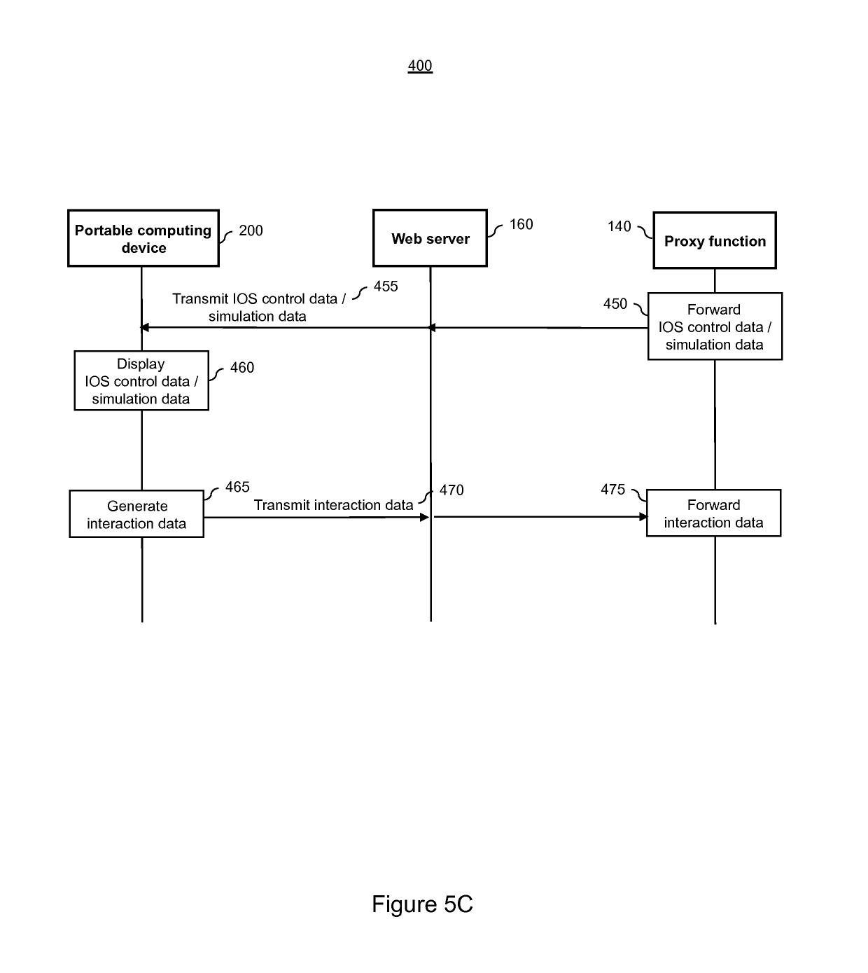

Reference is now made concurrently to FIGS. 2A, 2B, 4A, 4B, 5A, 5B and 5C, where FIGS. 5A, 5B and 5C represent an exemplary flow diagram 400 illustrating the interactions between the portable computing device 200, the web server 160, an instance of rendering function 150 (e.g. 150A or 150B) and a proxy function 140 (e.g. 140A or 140B).

At step 410, the web client function 210 of the portable computing device 200 initiates a web session with the web server 160. For example, the user of the portable computing device 200 enters a Uniform Resource Locator (URL) corresponding to a simulation portal hosted by the web server 160, and the web client function 210 requests a connection to the simulation portal. In return, the web server 160 returns a home page of the simulation portal to be displayed by the web client function 210 of the portable computing device 200.

At step 415, the user of the portable computing device 200 enters its credentials, and the web client function 210 transmits the credentials to the web server 160. The web server 160 verifies if the user is authorized to connect to the simulation portal based on the user credentials, and grants/denies access to the simulation portal based on the result of the verification of the user credentials. This step is optional, but is usually implemented to avoid that any user is granted access to the simulation portal without restrictions. An administrator of the simulation portal may be granted access to management functionalities of the portal, while standard users generally only have access to simulation functionalities of the portal.

At step 420, the web server 160 transmits a list of candidate simulation functionalities 110 (e.g. Weather function, Navigation function, etc.) to the web client function 210 of the portable computing device 200. The list may be determined based on a particular profile of the user, and may comprise only a subset (e.g. Weather function only) of all available simulation functionalities 110 supported by the web server 160. The subset corresponds to simulation functionalities 110 (e.g. Weather function only) that the user of the portable computing device 200 is authorized to use based on its profile. For each potential user, the web server 160 stores a profile of the user for determining the corresponding authorized simulation functionalities 110. The profile of each potential user can be generated by an administrator of the web server 160. For example, in the case of an aircraft simulation, the user may only be authorized to use simulation functionalities 110 corresponding to one or more particular type(s) of aircraft, to one or more particular system(s) or sub-system(s) of an aircraft, to military or civilian aircrafts only, etc. The web client function 210 of the portable computing device 200 displays the list of candidate simulation functionalities 110 (e.g. Weather function and Navigation function) for allowing the user to select one among the list of candidates. The selection of a particular simulation functionality (e.g. Weather function) in the list of candidate simulation functionalities 110 by the user is transmitted to the web server 160 by the web client function 210 of the portable computing device 200.

As mentioned previously, a dedicated proxy function 140 (e.g. Weather proxy function 140B represented in FIG. 2B) provides an interface between the selected simulation functionality 110 (e.g. Weather function) and other components of the simulator (e.g. IOS functionality 120, etc.). If the dedicated proxy function 140 (e.g. Weather proxy function 140B) is not active, it is launched by the web server 160. Furthermore, the web server 160 establishes an internal communication channel (internal to the simulator 100) with the dedicated proxy function 140 (e.g. Weather proxy function 140B) for exchanging data between the portable computing device 200 and the IOS functionality 120; as well as between the portable computing device 200 and the selected simulation functionality 110 (e.g. Weather function) if needed. The data are exchanged through the web server 160 and the dedicated proxy function 140 (e.g. Weather proxy function 140B). The data exchanged through this internal communication channel do not need to be adapted for rendering on the portable computing device 200 via a rendering function 150 (e.g. 150B). Establishing the internal communication channel between components of the simulator 100 (e.g. software programs executed by the same or different processing units) is well known in the art.

The selected simulation functionality 110 (e.g. Weather function) may automatically provide access to corresponding IOS function(s) of the IOS functionality 120 (e.g. function IOS_2), via the dedicated proxy function 140 (e.g. Weather proxy function 140B). Alternatively, an interactive selection step 422 similar to selection step 420 is performed. At step 422, the web server 160 transmits a list of candidate IOS function(s) of the IOS functionality 120 (e.g. function IOS_1, function IOS_2, etc.) to the web client function 210 of the portable computing device 200. The list may be determined based on a particular profile of the user, and may comprise only a subset (e.g. function IOS_2 only) of all available IOS functions of the IOS functionality 120 supported by the web server 160. The subset corresponds to IOS functions of the IOS functionality 120 (e.g. function IOS_2 only) that the user of the portable computing device 200 is authorized to use based on its profile. For each potential user, the web server 160 stores a profile of the user for determining the corresponding authorized IOS functions of the IOS functionality 120. The web client function 210 of the portable computing device 200 displays the list of candidate IOS functions of the IOS functionality 120 (e.g. function IOS_1 and function IOS_2) for allowing the user to select one among the list of candidates. The selection of a particular IOS function of the IOS functionality 120 (e.g. function IOS_2) in the list of candidate IOS functions of the IOS functionality 120 by the user is transmitted to the web server 160 by the web client function 210 of the portable computing device 200. The web server 160 configures the dedicated proxy function 140 (e.g. Weather proxy function 140B) to provide access to the selected (and authorized) IOS function of the IOS functionality 120 (e.g. function IOS_2) to the portable computing device 200, through the web server 160 and dedicated proxy function 140.

At step 425, the web server 160 launches an instance of rendering function 150 (e.g. Weather rendering function 150B represented in FIG. 2B) corresponding to the simulation functionality 110 (e.g. Weather function) selected at step 420. The launched instance of rendering function 150 (e.g. Weather rendering function 150B) may execute on the same processing unit as the web server 160 (FIG. 4C), or on another processing unit 110 (FIGS. 4B and 4D). Launching software on a remote processing unit is a mechanism well known in the art.

Although a single portable computing device 200 is represented in FIGS. 5A, 5B and 5C for simplification purposes, the web server 160 is capable of managing one or more portable computing devices 200 having initiated a web session at step 410 for interacting with the simulator 100. Furthermore, although a single instance of rendering function 150 is represented in FIG. 5B for simplification purposes, for each portable computing device 200, the web server 160 may launch one or more instances of rendering function 150 respectively corresponding to one or more simulation functionalities 110 selected at step 420.

The web server 160 establishes an external communication channel between the instance of rendering function 150 (e.g. Weather rendering function 150B) launched at step 425 and the portable computing device 200, for transmitting simulation data adapted for rendering on the portable computing device 200. Establishing the external communication channel is well known in the art, and may comprise determining a connection identification, selecting communication protocol(s), allocating communication sockets, etc.

The web server 160 may create and manage a dynamic communication profile for each portable computing device 200, comprising characteristics of the one or more internal communication channels created for allowing an exchange of data between the portable computing device 200 and the IOS functionality/simulation functionalities 110 through the web server 160. The dynamic communication profile also comprises characteristics of the one or more external communication channels created for allowing transmission of adapted simulation data from one or more rendering functions 150 to the portable computing device 200. The management of the dynamic communication profile includes creation/update/deletion of the internal and external communication channels.

Furthermore, the web server 160 provides the launched instance of rendering function 150 with characteristics of the portable computing device 200. The characteristics include for example processing power, memory size, display resolution, data throughput of a communication interface, available user interfaces, etc. These characteristics are used by the launched instance of rendering function 150 for performing the adaptation of the simulation data transmitted to the portable computing device 200. For each authorized user of the simulation portal, the web server 160 may store a static profile (with the aforementioned characteristics) of the portable computing device 200 used by the user. Alternatively, the web server 160 automatically generates a dynamic profile (with the aforementioned characteristics) of the portable computing device 200 used by the user at step 410, by dynamically retrieving the characteristics of the device 200 currently used by the user (this procedure is well known in the art of web browsing).

FIG. 5B more specifically represents the transmission of adapted simulation data by the instance of rendering function 150 to the portable computing device 200

At step 430, the proxy function 140 (e.g. Weather proxy function 140B) forwards simulation data generated by the simulation functionality 110 selected at step 420 (e.g. Weather function) to the corresponding instance of rendering function 150 (e.g. Weather rendering function 150B). The simulation functionality 110 is not represented in FIG. 5B for simplification purposes. The interactions between the simulation functionality 110 and the proxy function 140 have been previously detailed in relation to FIGS. 2A and 2B.

At step 435, the instance of rendering function 150 generates simulation data adapted (based on the aforementioned characteristics of the portable computing device 200) for rendering on the portable computing device 200.

At step 440, the adapted simulation data are transmitted by the instance of rendering function 150 to the portable computing device 200.

At step 445, the display function 220 of the portable computing device 200 processes the adapted simulation data received from the instance of rendering function 150, and displays the processed simulation data on the display 204 of the portable computing device 200. Since the simulation data have been adapted to the device 200 at step 435, the processing is very limited and may even not be needed before displaying the simulation data. This step will be detailed later in the description.

Although a single sequence of steps 430, 435, 440 and 445 is represented in FIG. 5B for simplification purposes, a plurality of sequences may occur. For each sequence, simulation data adapted for interacting with the portable computing device 200 are generated at step 435, transmitted at step 440 and displayed at step 445.

FIG. 5C more specifically represents the exchange of data not adapted by a rendering function between the web server 160 and the portable computing device 200.

At step 450, the proxy function 140 (e.g. Weather proxy function 140B) forwards IOS control data generated by an IOS function (e.g. function IOS_2) of the IOS functionality 120 selected at step 422 and/or forwards simulation data (not adapted by a rendering function) generated by the simulation functionality 110 selected at step 420 (e.g. Weather function), to the web server 160. The simulation functionality 110 and IOS functionality 120 are not represented in FIG. 5C for simplification purposes. The interactions between the simulation functionality 110/IOS functionality 120 and the proxy function 140 have been previously detailed in relation to FIGS. 2A and 2B.

At step 455, the IOS control data and/or simulation data are transmitted by the web server 160 to the portable computing device 200 (without applying any rendering function).

At step 460, the display function 220 of the portable computing device 200 displays the received IOS control data and/or simulation data on the display 204 of the portable computing device 200. This step will be detailed later in the description.

At step 465, the interaction function 230 of the portable computing device 200 generates interaction data based on interactions of the user of the portable computing device 200 (e.g. with IOS control data displayed at step 460). This step will be detailed later in the description.

At step 470, the interaction data are transmitted by the portable computing device 200 to the web server 160. The web server 160 simply forwards the interaction data to the proxy function 140.

The web server 160 may implement a filtering function (not represented in the Figures), for identifying and adequately handling the data received from the portable computing device(s) 200. The filtering function identifies interaction data received at step 470, which shall be forwarded to the proper proxy function 140. The filtering function also identifies administrative and management data received at steps 410, 415, 420 and 422 of FIG. 5A, which shall be processed locally by the web server 160.

At step 475, the proxy function 140 forwards the interaction data to the proper IOS function of the IOS functionality 120 (the one that generated the IOS control data referenced at step 450 corresponding to the received interaction data). The interactions between the IOS functionality 120 and the proxy function 140 have been previously detailed in relation to FIGS. 2A and 2B, including the processing of interaction data by the IOS functionality 120 for controlling the execution of the simulation executed by the simulator 100.

Although a single sequence of steps 450, 455 and 460 is represented in FIG. 5C for simplification purposes, a plurality of sequences may occur. Similarly, a plurality of sequences of steps 465, 470 and 475 may occur. A plurality of sequences of steps 450, 455 and 460 may occur before a sequence of steps 465, 470 and 475 occurs. Similarly, a plurality of sequences of steps 465, 470 and 475 may occur before a sequence of steps 450, 455 and 460 occurs. However, a sequence of steps 465, 470 and 475 is generally followed by a sequence of steps 450, 455 and 460 (and/or steps 430, 435, 440 and 445 of FIG. 5B); since the processing of the interaction data impacts the execution of the simulation executed by the simulator 100, which in turn leads to the generation of new data which are transmitted to the portable computing device 220.

Although the transmission of simulation data and IOS control data have been represented together in FIG. 5C for simplification purposes (steps 450 and 455), the transmission of these two types of data occurs independently of one another since they are generated by two independent components of the simulator (respectively the simulation functionalities 110 and the IOS functionality 120).

Furthermore, the transmission of simulation data adapted by the rendering function 150 as illustrated in FIG. 5B and the transmission of simulation data/IOS control data by the web server 160 (without adaptation by a rendering function) as illustrated in FIG. 5C occur simultaneously and independently.

As is well known in the art, the communications between the web server 160 and portable computing device(s) 200 use the Hypertext Transfer Protocol (HTTP) and/or Hypertext Transfer Protocol Secure (HTTPS). Optionally, the Real-time Transport Protocol (RTP) may also be used for some of the data exchanged between the web server 160 and device(s) 200. A single step represented in FIGS. 5A and 5C (e.g. 410, 415, 420, 422, 455 and 740) may include a plurality of HTTP/HTTPS/RTP messages exchanged between the web server 160 and device(s) 200.

Similarly, the communications between the rendering function(s) 150 and portable computing device(s) 200 may also use the HTTP and/or HTTPS and/or RTP protocols. A single step represented in FIG. 5B (e.g. 440) may include a plurality of HTTP/HTTPS/RTP messages exchanged between the rendering function(s) 150 and device(s) 200. In this case, each rendering function 150 implements an autonomous HTTP based server allowing communications with the portable computing device(s) 200 via web sockets. As mentioned previously, the establishment of the external communication channel between the rendering function(s) 150 and portable computing device(s) 200 is performed under the direction of the web server 160 at step 425.

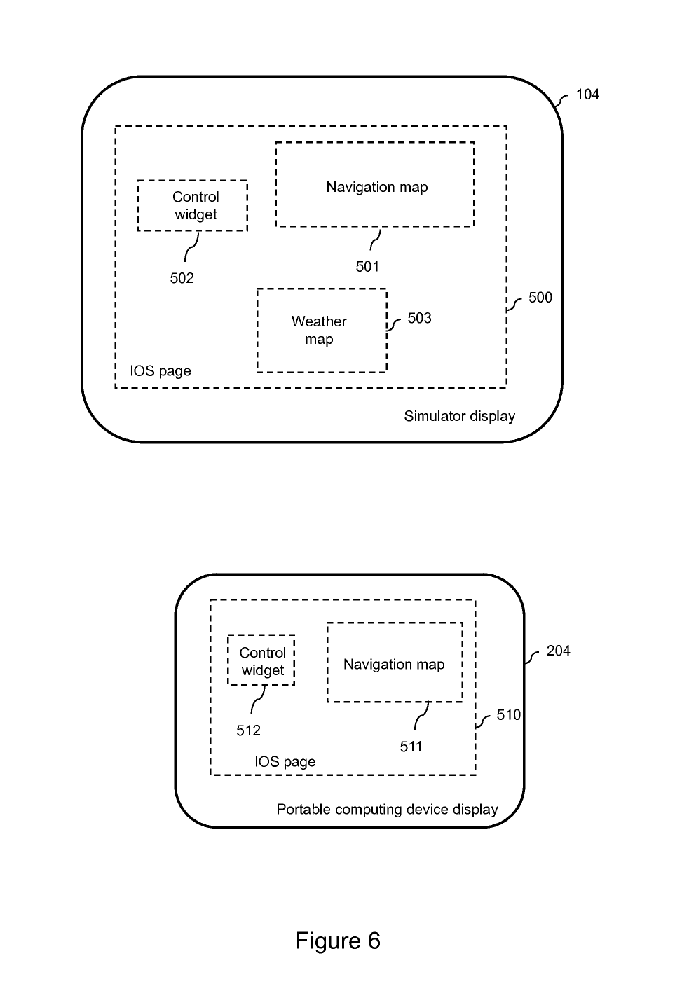

Reference is now made concurrently to FIGS. 2A, 2B, 4A, 4B and 6. FIG. 6 represents an IOS page 500 displayed on the display 104 of the simulator 100. The IOS page 500 is displayed by the IOS functionality 120. An IOS page generally includes graphical control elements (e.g. menus and sub-menus, list boxes, etc.) for controlling simulation parameters, and graphical display elements (e.g. images, text fields, icons, embedded videos, etc.) for displaying simulation data generated by the simulation functionalities 110.

The IOS page 500 represented in FIG. 6 comprises a first image 501 (Navigation map), a graphical control element 502 (control widget), and a second image 503 (Weather map). The Navigation map is generated by the Navigation function of the simulation functionalities 110 and transmitted to the IOS functionality 120 by the Navigation proxy function 140A for display on the simulator display 104. The Navigation map is updated based on the execution of the Navigation function of the simulation functionalities 110. The Weather map 503 is generated by the Weather function of the simulation functionalities 110 and transmitted to the IOS functionality 120 by the Weather proxy function 140B for display on the simulator display 104. The Weather map is updated based on the execution of the Weather function of the simulation functionalities 110. The control widget 502 is used by the instructor 10 for modifying parameters related to the Navigation map 501 and the Weather map 503, when the instructor 10 interacts directly with the simulator 100 as illustrated in FIG. 1. The IOS page 500 may be displayed by a single IOS function (not represented in the Figures) of the IOS functionality 120, or by a combination of functions (e.g. function IOS_1 displays the Navigation map as illustrated in FIG. 2A and function IOS_2 displays the Weather map as illustrated in FIG. 2B) of the IOS functionality 120.

FIG. 6 also represents an IOS page 510 displayed on the display 204 of the portable computing device 200. The IOS page 510 is displayed by the display function 220 of the portable computing device 200. The IOS page 510 comprises an image 511 (Navigation map) corresponding to the Navigation map 501 of the IOS page 500, and a graphical control element 512 (control widget) corresponding to the control widget 502 of the IOS page 500.

For illustration purposes, the user of the portable computing device 200 has decided not to use the Weather function of the simulation functionalities 110, and consequently an image corresponding to the Weather map 503 of the IOS page 500 is not displayed on the display 204 of the portable computing device 200. In an alternative use case not represented in FIG. 6, if the user of the portable computing device 200 had decided to use the Weather function of the simulation functionalities 110, an image corresponding to the Weather map 503 of the IOS page 500 would be displayed on the display 204 of the portable computing device 200.

The Navigation rendering function 150A receives simulation data corresponding to the Navigation map 511 from the Navigation function of the simulation functionalities 110 via the Navigation proxy function 140A. The Navigation rendering function 150A processes the simulation data to generate the Navigation map 511 adapted for rendering on the portable computing device 200. For example, the size and resolution of the Navigation map 511 is adapted to characteristics (e.g. screen resolution, etc.) of the portable computing device 200. The Navigation map 511 is transmitted to the portable computing device 200 by the Navigation rendering function 150A, and displayed on the display 204 by the display function 220.

The web server 160 receives IOS control data corresponding to the control widget 512 (allowing control of the Navigation map 511) from the IOS functionality 120 via the Navigation proxy function 140A. The IOS control data are transmitted to the portable computing device 200 by the web server 160, and the control widget 512 is displayed on the display 204 by the display function 220 based on the received IOS control data.

When the instructor 10 interacts with the IOS page 510 via a user interface of the portable computing device 200, corresponding interaction data are generated and transmitted by the interaction function 230 of the portable computing device 200 to the web server 160. The web server 160 forwards the interaction data to the IOS functionality 120 via the Navigation proxy function 140A.

For example, the control widget 512 is a menu comprising three items. When the instructor 10 positions a pointer (corresponding to a mouse) on one of the items and left clicks, the transmitted interaction data comprise the selected item.

Alternatively or complementarity, the instructor 10 may interact directly with an area of the IOS page 510 without using the control widget 512. For example, the instructor 10 may position a pointer (corresponding to a mouse) on the Navigation map 511, and left click or right click on the Navigation map 511. The transmitted interaction data comprise an indication that the instructor interacted with the Navigation map 511, and more specifically via a right click or a left click. The interaction data are interpreted by the IOS functionality 120 as follows: a left quick is a zoom-in request and a right click is a zoom-out request. The IOS functionality 120 reconfigures the Navigation function of the simulation functionalities 110 accordingly (via the Navigation proxy function 140A). In case of a zoom-in, the Navigation function of the simulation functionalities 110 generates more detailed simulation data, which are processed by the Navigation rendering function 150A for generating a zoomed-in Navigation map 511 for rendering on the portable computing device 200. In case of a zoom-out, the Navigation function of the simulation functionalities 110 generates less detailed simulation data, which are processed by the Navigation rendering function 150A for generating a zoomed-out Navigation map 511 for rendering on the portable computing device 200.

More generally, the interaction data are used by the IOS functionality 120 for controlling the execution of the simulation by the simulator 100. More precisely, the interaction data are used by the IOS functionality 120 for controlling the corresponding simulation functionality 110 (e.g. Navigation function) via the proper proxy function 140 (e.g. Navigation proxy function 140A). Controlling the corresponding simulation functionality 110 includes controlling the simulation data generated by the simulation functionality 110 (e.g. Navigation function), which are further adapted by the corresponding rendering function 150 (e.g. Navigation rendering function 150A) for rendering (e.g. Navigation map 511) on the portable computing device display 204.

The web server 160 may pre-process the received interaction data to determine if they correspond to a legitimate interaction with the IOS page 510 displayed on the portable computing device 200. The web server 160 simply discards transmitted interaction data which do not correspond to a legitimate interaction with the IOS page 500, and transmits legitimate interactions to the IOS functionality 120. The web server 160 further discriminates the interaction data with the IOS page 500 from administrative and configuration data represented in FIG. 5A, which are processed directly by the web server 160.

With respect to the Navigation map 511, the generation of simulation data adapted for rendering on the portable computing device 200 by the Navigation rendering function 150A consists in generating a succession of static images corresponding to the Navigation map 511, based on simulation data generated by the Navigation function of the simulation functionalities 110. The simulation data may allow the generation by the Navigation rendering function 150A of two dimensional (2D) or three dimensional (3D) images.

### Flow of Simulation Images

Referring now concurrently to FIGS. 2A, 2B, and 4A to 4D, in a particular aspect, the simulation data generated by an instance of rendering function (e.g. 150A or 150B) consist in a flow of simulation images adapted for display on the portable computing device 200. The flow of simulation images is transmitted to the portable computing device 200 by the instance of rendering function (e.g. 150A or 150B). As mentioned previously, the flow of simulation images is representative of the execution of the simulation by the simulator 100. For instance, in the case of a flight simulator, the flow of simulation images may correspond to a real time rendering of a map (e.g. a Weather map generated by the Weather rendering function 150B, a Navigation map generated by the Navigation rendering function 150A, etc.), a real time rendering of a simulated view from the cockpit (generated by a rendering function not represented in the Figures), etc.

In a legacy mode of operation of the simulator 100 (corresponding to FIG. 1), the real time rendering is performed by one of the IOS functionality 120, the simulation functionalities 110 and the out of window functionality 130, based on simulation data generated by a particular simulation functionality 110 (e.g. Weather function or Navigation function). The real time rendering generates a flow of images for display on at least one display 104 of the simulator 100.

In a mode of operation of the simulator 100 involving the rendering functions (150A and 150B), an instance of rendering function (e.g. 150A or 150B) generates a particular flow of simulation images adapted for display on the portable computing device 200, based on the simulation data generated by a particular simulation functionality 110 (e.g. Weather function or Navigation function).

The adapted flow of simulation images, generated and transmitted by the instance of rendering function (e.g. 150A or 150B), is received by the portable computing device 200 via its communication interface 203, and processed by the display function 220 for display on the display 204. As will be detailed later in the description, the processing may simply consist in displaying the received flow of simulation images on the display 204. Alternatively, the flow of simulation images is applied a particular processing algorithm before display. For example, a specific decompression algorithm may be applied by the display function 220 if a corresponding compressing algorithm has been applied by the instance rendering function (e.g. 150A or 150B) when generating the flow of simulation images.

As mentioned previously, the web server 160 may determine characteristics of the portable computing device 200, and the instance of rendering function (e.g. 150A or 150B) uses these characteristics for generating the flow of simulation images adapted for display on the portable computing device 200. Such characteristics have been mentioned previously, and include for example processing power of the processing unit 201, memory size of the memory 202, display resolution of the display 204, data throughput of the communication interface 203, etc. Using one or more characteristics of the portable computing device 200 for generating the flow of images may comprise at least one of the following: encoding the flow of simulation images in a particular format (e.g. JPEG, GIF, TIFF, PNG, etc.) selected based on the characteristics, compressing the flow of simulation images with a particular compression algorithm selected based on the characteristics, sampling the flow of simulation images with a particular sampling algorithm selected based on the characteristics, using a particular algorithm for lowering an image resolution for the flow of simulation images selected based on the characteristics, etc.

Compression algorithms are well known in the art. They allow for a reduction of the amount of data transmitted over the network 30 (which may be congested), and received by the communication interface 203 (which may be operating at full capacity) of the portable computing device 200.

Sampling algorithms are well known in the art. They allow for a reduction of the amount of data transmitted over the network 30 (which may be congested), and received by the communication interface 203 (which may be operating at full capacity) of the portable computing device 200. They also reduce the amount of data that need to be processed by the processing unit 201 of the portable computing device 200. However, data sampling implies a loss of data, and may therefore not be applicable to all types of flows of simulation images. Furthermore, the sampling rate is adapted to each particular flow of simulation images, to avoid losing information in the images.

Algorithms for lowering the resolution of images are well known in the art. They allow for a reduction of the amount of data transmitted over the network 30 (which may be congested), and received by the communication interface 203 (which may be operating at full capacity) of the portable computing device 200. For instance, for a nominal flow of simulation image generated by the simulator 100 with a resolution of 1920 by 1080 pixels, the instance of rendering function (e.g. 150A or 150B) generates an adapted flow of simulation images with a resolution of 1280 by 720 pixels for visualization on the display 204 of the portable computing device 200. Lowering of image resolution is only applicable to specific instances of rendering functions (e.g. 150A) where the generated flow of simulation images does not include too many details or too many items of small size.

A single characteristic may be taken into account for generating the flow of simulation images. Alternatively, a combination of characteristics is taken into account. The characteristic(s) taken into account may also depend on the particular flow of images generated. For example, based on the data throughput of the communication interface 203, the instance of rendering function (e.g. 150A or 150B) may select to apply a particular data compression algorithm to the flow of simulation images, if the processing power of the processing unit 201 and the memory size of the memory 202 are sufficient to apply a corresponding decompression algorithm to the flow of simulation images received at the portable computing device 200. Alternatively, if the processing power of the processing unit 201 and the memory size of the memory 202 are not sufficient to apply the corresponding decompression algorithm, the instance of rendering function (e.g. 150A or 150B) selects to apply another data compression algorithm which requires less processing power and memory size on the decompressing side. In another alternative, the instance of rendering function (e.g. 150A or 150B) selects to apply a data sampling algorithm to the flow of simulation images (e.g. drop an image every three images) in place of a data compression algorithm.

If characteristics of the portable computing device 200 are not available, or if a particular instance of rendering function (e.g. 150A) is configured for not using these characteristics, the instance may still apply to the flow of simulation images at least one of the following image processing algorithms: an encoding in a particular format (e.g. JPEG, GIF, TIFF, PNG, etc.), a particular compression algorithm, a particular image sampling algorithm, a particular algorithm for lowering image resolution, etc. The applied image processing algorithm(s) may be pre-defined in a configuration file of the particular instance of rendering function (e.g. 150A). Alternatively, specific image processing algorithm(s) are selected by the particular instance of rendering function (e.g. 150A) based on the particular flow of simulation images to be generated.

The adaptation (via one of the aforementioned image processing algorithms) of the flow of simulation images based on characteristics of the portable computing device 200 considered in the present embodiment is static (based on static characteristics of the portable computing device 200). In an alternative embodiment, the adaptation may be dynamic, by collecting in (almost) real time dynamic characteristics of the portable computing device 200, and adapting (almost) in real time the flow of simulation images to the collected dynamic characteristics.

Referring now concurrently to FIGS. 2A, 2B and 3, as mentioned previously in the description, the simulator 100 may simultaneously transmit a plurality of flows of simulation images to the portable computing device 200 via a plurality of instances of rendering function (e.g. 150A and 150B) operating in parallel. For instance, as illustrated in FIG. 2A, a first instance of rendering function 150A generates a first flow of simulation images corresponding to the Navigation function of the simulation functionalities 110 (e.g. real time rendering of a Navigation map) and a second instance of rendering function 150B generates a second flow of simulation images corresponding to the Weather function of the simulation functionalities 110 (e.g. real time rendering of a Weather map). The first and second flows of simulation images are simultaneously transmitted to the portable computing device 200 (respectively by the instances of rendering function 150A and 150B), for being displayed simultaneously on the display 204 of the portable computing device 200.

Furthermore, as mentioned previously in the description, the simulator 100 may transmit a plurality of flows of simulation images to a plurality of portable computing devices 200 via a plurality of instances of rendering function (e.g. 150A and 150B) operating in parallel. For instance, as illustrated in FIG. 3, a first instance of rendering function 150B generates a first flow of simulation images corresponding to the Weather function of the simulation functionalities 110 (e.g. real time rendering of a Weather map), which is transmitted to a first portable computing device 200 by the instance of rendering function 150B. A second instance of rendering function 150C generates a second flow of simulation images also corresponding to the Weather function of the simulation functionalities 110 (e.g. real time rendering of a Weather map), which is transmitted to a second portable computing device 200′ by the instance of rendering function 150C.

Referring now to FIG. 4D, as mentioned previously in the description, the web server function 160 may be implemented outside of the simulator 100 by a standalone server 300. In this configuration, a plurality of simulators 100 (a single simulator 100 is represented in FIG. 4D for simplification purposes) can transmit a plurality of flows of simulation images to a plurality of portable computing devices 200 (a single portable computing device 200 is represented in FIG. 4D for simplification purposes), under the control of the web server function 160. More specifically, the web server function 160 determines the instances of rendering functions (e.g. 150A and 150B) launched on the plurality of simulators for generating the plurality of flows of simulation images. The determination is based on requests from the users of the portable computing devices 200 to interact with particular simulation functionalities 110 and/or with particular IOS functions of the IOS functionality 120. The determination further takes into consideration the respective authorizations of each user for interacting with the particular simulation functionalities 110 and/or with the particular IOS functions of the IOS functionality 120. The instances of rendering functions (e.g. 150A and 150B) are created and configured on demand by the web server 160, based on the user requests and authorizations.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A simulator for generating and transmitting a flow of simulation images adapted for display on a portable computing device, the simulator comprising:
a processing unit for:
executing a simulation; and
executing at least one rendering function, the rendering function generating a flow of simulation images adapted for display on the portable computing device and transmitting the flow of simulation images to the portable computing device, the flow of simulation images being representative of the execution of the simulation.

2. The simulator of claim 1, wherein the flow of simulation images is transmitted via a communication interface of the simulator, and the communication interface supports at least one of the following communication protocols: Wi-Fi, and Ethernet.

3. The simulator of claim 1, wherein the simulator transmits a plurality of flows of simulation images to the portable computing device.

4. The simulator of claim 1, wherein the simulator transmits a plurality of flows of simulation images to a plurality of portable computing devices.

5. The simulator of claim 1, wherein generating the flow of simulation images comprises at least one of the following: encoding the flow of simulation images in a particular format, applying a particular compression algorithm to the flow of simulation images, applying a particular image sampling algorithm to the flow of simulation images, and applying a particular algorithm for lowering an image resolution of the flow of simulation images.

6. The simulator of claim 5, wherein the particular encoding format is one of the following: JPEG, GIF, TIFF, and PNG.

7. The simulator of claim 1 further comprising a web server, wherein the web server receives interaction data from the portable computing device, and the processing unit processes the interaction data and controls the execution of the simulation based on the processed interaction data.

8. The simulator of claim 7, wherein the web server is executed by the processing unit.

9. The simulator of claim 7, wherein the simulator comprises a second processing unit for executing the web server.

10. The simulator of claim 1 further comprising a web server, wherein executing the simulation by the processing unit comprises executing at least one simulation functionality by the processing unit, and the web server launches a particular rendering function corresponding to a particular simulation functionality selected by a user of the portable computing device among a list of candidate simulation functionalities currently executed by the processing unit.

11. The simulator of claim 1 further comprising a web server, wherein the web server determines characteristics of the portable computing device, and the at least one rendering function generates the flow of simulation images adapted for display on the portable computing device based on the characteristics of the portable computing device.

12. The simulator of claim 11, wherein generating the flow of simulation images based on the characteristics of the portable computing device comprises at least one of the following: encoding the flow of simulation images in a particular format, applying a particular compression algorithm to the flow of simulation images, applying a particular image sampling algorithm to the flow of simulation images, and applying a particular algorithm for lowering an image resolution of the flow of simulation images.

13. The simulator of claim 11, wherein the characteristics of the portable computing device include at least one of the following: processing power, memory size, display resolution, and data throughput of a communication interface.

14. The simulator of claim 1, wherein the flow of simulation images correspond to a real time rendering of a map.

15. A system for generating and transmitting a flow of simulation images adapted for display on a portable computing device, the system comprising:
a simulator, comprising:
a processing unit for:
executing a simulation;
executing at least one rendering function, the rendering function generating a flow of simulation images adapted for display on the portable computing device and transmitting the flow of simulation images to the portable computing device, the flow of simulation images being representative of the execution of the simulation; and
processing interaction data and controlling the execution of the simulation based on the processed interaction data;
a communication interface for:
receiving the interaction data from a web server;
the web server for:
forwarding the interaction data received from the portable computing device to the simulator.

16. The system of claim 15, comprising a plurality of simulators exchanging simulation data and interaction data with a plurality of portable computing devices, the interaction data being exchanged via the web server.

17. The system of claim 15, wherein generating the flow of simulation images comprises at least one of the following: encoding the flow of simulation images in a particular format, applying a particular compression algorithm to the flow of simulation images, applying a particular image sampling algorithm to the flow of simulation images, and applying a particular algorithm for lowering an image resolution of the flow of simulation images.

18. The system of claim 15, wherein executing the simulation by the processing unit comprises executing at least one simulation functionality by the processing unit, and the web server launches a particular rendering function corresponding to a particular simulation functionality selected by a user of the portable computing device among a list of candidate simulation functionalities currently executed by the processing unit.

19. The system of claim 15, wherein the web server determines characteristics of the portable computing device, and the at least one rendering function generates the flow of simulation images adapted for display on the portable computing device based on the characteristics of the portable computing device.

20. The system of claim 15, wherein the flow of simulation images correspond to a real time rendering of a map.
